(19) United States
(12) Patent Application Publication
(10) Pub. No.: US 2017/0157595 A1
(43) Pub. Date: Jun. 8, 2017

(54) NOVEL CATALYST FOR THE WATER GAS SHIFT REACTION

(71) Applicant: Auxilium Green, LLC, Bedminster, NY (US)

(72) Inventors: Divyanshu R. Acharya, Bedminster, NJ (US); Ranjan K. Sahoo, Bedminster, NJ (US); Richard G. Herman, Bedminstger, NJ (US)

(73) Assignee: Auxilium Green, LLC, Bedminster, NJ (US)

(21) Appl. No.: 14/959,167

(22) Filed: Dec. 4, 2015

(51) Int. Cl. B01J 27/051; C01B 3/16; B01J 21/18; B01J 37/02; B01J 37/20; B01J 37/18

(52) U.S. Cl. CPC B01J 27/051; B01J 37/20; B01J 37/18; B01J 21/18; B01J 37/0201; C01B 3/16; C01B 2203/0283; C01B 2203/1041; C01B 2203/1082

(57) ABSTRACT

A method of increasing hydrogen content of a synthesis gas via a water-gas shift reaction includes providing a catalyst composition comprising cesium, molybdenum and sulfur on an inert support. A reactant gas mixture including synthesis gas (carbon monoxide and hydrogen) and steam, when flowed into contact with the catalyst composition, may form a hydrogen enriched shifted gas mixture.

### BACKGROUND

The water-gas shift reaction (WGSR) is used to adjust and/or enhance the hydrogen content of synthesis gas. Synthesis gas, also termed syngas, is a mixture of hydrogen and carbon monoxide and may be generated by gasification of carbonaceous feedstocks such as coal, petroleum coke, biomass, municipal solid waste or other carbon-rich feedstocks, or by partial oxidation or steam reforming of natural gas. The WGSR is an important industrial reaction that is involved in the manufacture of ammonia, hydrocarbons, methanol, and hydrogen. It is also often used in conjunction with steam reforming of methane and other hydrocarbons. In the Fischer-Tropsch process, the WGSR is one of the most important reactions used to adjust the H₂/CO ratio. It provides a source of hydrogen at the expense of carbon monoxide, which is important for the production of high purity hydrogen for use in ammonia synthesis, or to achieve a gas stoichiometry suitable for the production of methanol or other higher alcohols.

The WGSR is carried out by passing the raw synthesis gas, in the presence of steam, over a suitable water gas shift catalyst at elevated temperatures. The reaction may be depicted as follows;

H₂O+CO [symbol] H₂+CO₂

The reaction is exothermic and equilibrium limited. The equilibrium conversion of carbon monoxide is favored at low temperatures, while high reaction temperatures enhance the reaction rates. The reaction rate and conversion of carbon monoxide are significantly affected by the reaction temperature. The reaction pressure has little or no effect on the conversion of carbon monoxide.

The WGSR is frequently carried out in two stages. In the first stage, the reactor is operated in a temperature range of 300-450° C. This stage is called the high temperature shift or the HTS stage. The carbon monoxide concentration is decreased in this stage from an inlet value of more than 10 mol % to about 2-4 mol %. The second stage, also known as the low temperature shift or the LTS stage, employs another reactor operated in a lower temperature range typically between 160-250° C. The carbon monoxide concentration after this stage reduces to less than 1 mol %.

Conventional catalysts for the water gas shift reaction fall into two categories—those that can operate with sweet feed (i.e., no sulfur compounds present in the feed syngas) and those that can operate with sour feed (i.e. feed syngas contain sulfur compounds). For sweet syngas feeds, there are two types of WGSR catalysts employed—ones that operate at low reaction temperatures (between 200-250° C.) and others that operate at high reaction temperatures (between 350-550° C.). Commercial low temperature WGSR catalysts typically consist of Cu/ZnO/Al₂O₃ catalysts. These catalysts cannot be used at high temperatures because of sintering and deactivation concerns. Commercial high temperature WGSR catalysts consist of Fe/Cr oxides or Fe/Cr oxides promoted with a small amount of Cu. These catalysts are not active at low temperatures. Since the presence of sulfur will poison these catalysts, these catalysts are typically employed in a hydrogen plant based on steam reforming of natural gas feed. The natural gas feed has to be desulfurized apriori thus requiring an additional step, which in addition to the strict temperature regulation required, limits the applicability of sweet feed catalysts.

Since the syngas produced as a result of most gasification processes (e.g. gasification of coal, biomass, municipal solid waste etc.) contain sulfur, a sour WGSR catalyst resistant to sulfur poisoning allows the water gas shift reactor to be operated without prior removal of sulfur. The conventional sour WGSR catalysts include sulfided Co/Mo catalysts with a variety of supports, e.g. Al₂O₃, MgO, TiO₂, TiO₂/Al₂O₃ and MgAl₂O₄. These catalysts may contain Co or Ni for maintaining high activity in H₂S-containing gas streams for the WGSR. For example, the catalyst reported recently by Abbott et al. contains tungsten oxide or molybdenum oxide, a cobalt oxide or nickel oxide promoter, and an alkali metal oxide selected from sodium and potassium, all supported on a titanium catalyst support.

However, the sour WGSR catalysts are not active unless H₂S coexists in the reactant gas, and a minimum ratio of H₂S/H₂O is maintained. Additionally, these catalysts are often supplied in oxidized form and require sulfidation after loading the catalyst in the reactor. This results in longer start-up time of the reactor and requires the customer's facility to be equipped with the sulfidation capability.

This invention discloses a water gas shift reaction catalyst composition that addresses the above limitations.

### SUMMARY

In a first aspect of this disclosure, a method (and apparatus) for increasing hydrogen content of a synthesis gas via a water-gas shift reaction may include providing a catalyst composition comprising cesium, molybdenum and sulfur on an inert support is disclosed. The method may further include flowing a reactant gas mixture into contact with the catalyst composition and forming a hydrogen enriched shifted gas mixture. The reactant gas mixture may include synthesis gas (carbon monoxide and hydrogen) and steam. In an embodiment, the reaction gas mixture may include a steam to carbon monoxide volume ratio in the range of from 3 to 4. The water gas shift reaction may be a sour feed reaction or a sweet feed reaction.

In at least one embodiment, the catalyst composition may include molybdenum sulfide. Alternatively and/or additionally, the inert support may be activated carbon.

In an embodiment, the water gas shift reaction is carried out at a temperature of about 350 ° C. to 450 ° C. and/or at a pressure of at least 2.5 atm. Alternatively and/or additionally, the reactant gas mixture may be flowed at a gas hourly space velocity of from about 2400 L/kg catalyst/hr to 5000 L/kg catalyst/hr.

In some embodiments, the method may further include activating the catalyst composition before flowing the reactant gas mixture into contact with the catalyst composition by heating the catalyst composition to about 350 ° C. under a stream of hydrogen and nitrogen mixture.

In an embodiment, the carbon monoxide conversion may be at least 50%. And/or the carbon monoxide conversion may be from about 50% to 80%. Alternatively and/or additionally, carbon monoxide dry slip% in an outlet gas stream maybe from about 5% to 15%.

In an embodiment, the synthesis gas may include a hydrogen to carbon monoxide volume ratio in the range of from 1 to 3.

In another aspect of this disclosure, a method of preparing a catalyst composition may include forming oxides of molybdenum on an inert activated carbon support from a molybdenum oxide precursor, via impregnation. The method may further include simultaneously, sulfidizing and reducing, the formed molybdenum oxides, by passing a mixture of hydrogen sulfide and hydrogen in contact with the formed molybdenum oxides at a reaction temperature for a sufficient time to yield molybdenum disulfide, removing any hydrogen sulfide physically adsorbed on the molybdenum disulfide, and distributing cesium uniformly through said molybdenum- and sulfur-containing substance. The reaction temperature may be between 250° C. to about 650° C.

In an embodiment, the molybdenum oxide precursor may be ammonium molybdate tetrahydrate. In yet another embodiment, the molybdenum oxide precursor may be reduced and sulfidized at from about 250° C. to 650° C. The molybdenum oxide precursor solution may be applied in an amount sufficient to achieve a molybdenum loading of from about 10 wt % to 18 wt % based on the total weight of the impregnated inert activated carbon support.

In an embodiment, the cesium-containing compound solution may be applied in an amount sufficient to achieve a cesium to molybdenum mass ratio in the range of from 0.1 to 3 or preferably about 1. The cesium-containing compound may be cesium formate.

### BRIEF DESCRIPTION OF THE DRAWINGS

FIG. 1 is a flowchart illustrating a method of preparing a catalyst composition in accordance with one embodiment of the present invention.

FIG. 2 is a plot of X-ray diffraction patterns of molybdenum disulfide on activated carbon support and the final catalyst composition—cesium impregnated molybdenum disulfide on activated carbon support in accordance with one embodiment of the present invention.

FIG. 3 illustrates a graphical representation of the performance of the catalyst composition in the water-gas shift reaction under adiabatic conditions, according to an embodiment.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

The present invention is generally directed to a catalyst composition and method of using the same for use in the water gas shift reaction. The catalyst composition of this disclosure provides for a high water gas shift performance over a wide range of reaction conditions, and across a variety of reactant gas compositions that may include both sulfur containing and sulfur-free syngas feeds. The catalyst composition comprises, without limitation, a cesium promoted molybdenum disulfide catalyst and a catalyst support. The catalyst support is a high surface area material, which can be chosen from, but not limited to, silicon oxide, aluminum oxide, or activated carbon.

The terms “synthesis gas” or “syngas” refer to a gas mixture of hydrogen and carbon monoxide formulated as a starting material for conversion of carbon monoxide via catalytic processes of the present invention. Syngas can be produced from any hydrocarbon feedstock including natural gas, coal, petroleum coke, naphtha, municipal solid waste, landfill gas and biomass.

The term “catalyst composition” refers to a composition comprising an active material exhibiting catalytic activity suitable for catalytically promoting a desired reaction. The catalyst composition of the present invention can either be in an inactivated state or an activated state when exposed to conditions that make it more suitable for its intended purpose, which in the present invention relates to the conversion of carbon monoxide to hydrogen and carbon dioxide.

The term “water gas shift reaction” or WGSR refers to the conversion of carbon monoxide to carbon dioxide and hydrogen by reaction with steam according to the following equation:

H₂O+CO [symbol] H₂+CO₂

Generally, the catalyst composition includes an active material having a molybdenum- and sulfur-containing substance impregnated with an effective amount of cesium sufficient to promote WGSR, wherein the active material is at least substantially free of additional transition metals, including, but not limited to, cobalt and nickel.

In a further embodiment of the present invention, the catalyst composition comprises an active material having a molybdenum- and sulfur-containing substance impregnated with cesium, wherein the amount of molybdenum and sulfur is sufficient to promote WGSR, carried on or affixed to an inert support. The active material can be carried on or affixed to the inert support through any suitable means as known in the art, including but not limited to, impregnation and co-precipitation. The presence of cesium further enhances the catalyst activity and also reduces the formation of undesirable co-products such as methane and other hydrocarbons.

The catalyst composition preparation method of the current disclosure also provides for the introduction of sulfur in the active material in an intermediate step because molybdenum sulfides are very stable and as such do not require sulfur in the feed to maintain their sulfur level during WGSR. In contrast, most prior art methods require introduction of sulfur at the end, often after the loading of the currently available catalysts in the reactor, because the conventional CoMo sulfide catalysts lose sulfur due to the transformation of cobalt sulfides from an active phase CoS₂ to an inactive phase Co₉S₈, and require continuous replenishment of sulfur. An example of a suitable molybdenum- and sulfur-containing substance includes, but is not limited to, molybdenum disulfide.

The present invention will now be described for preparing the catalyst composition. The following description by no means limits the scope and spirit of the present invention.

In one embodiment of the present invention, there is provided a method of preparing a catalyst composition, including the steps of reacting molybdenum oxides with a sulfur source to produce a molybdenum- and sulfur-containing substance, wherein the molybdenum- and sulfur-containing substance is at least substantially free of any transition metals other than molybdenum, and distributing cesium uniformly through the molybdenum-and sulfur-containing substance.

The catalyst composition and a method of manufacturing the catalyst composition of the present disclosure are disclosed in the related patent publication U.S. Pat. No. 8,815,961, which is incorporated by reference herein in its entirety.

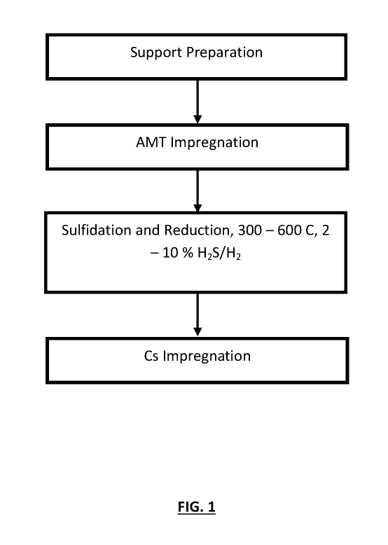

FIG. 1 depicts a flowchart showing a method of preparing the present catalyst composition. The method of preparing the present catalyst composition may include forming the molybdenum oxides, preferably on an inert support, from a molybdenum oxide precursor selected, for example, from ammonium molybdate tetrahydrate, molybdenum acetylacetonate, and ammonium molybdate salt prepared by mixing molybdic acid in ammonia solution.

In one embodiment of the present invention, the inert support is composed of a thermally stable material capable of enduring conditions under which the active material is subjected to during activation and catalyst activity. The inert support accelerates distribution of the syngas thereby enhancing contact of the syngas to the active material, while maintaining the mechanical integrity of the active material, Accordingly, the catalytic activity and selectivity of the active material is enhanced for greater throughput and improved WGSR with minimal quantity of undesirable side products formed, e.g. hydrocarbons. The inclusion of the inert support further minimizes formation of hot spots due to uneven distribution of the active material that may occur in a given reactor.

In one embodiment of the present invention, the inert support is preferably selected from an inert porous material having a relatively high surface area and should be neutral or basic or should be rendered neutral or basic upon alkali, such as cesium or potassium impregnation. In one embodiment of the present invention, the inert support includes a surface area of at least 850 m²/g, and preferably from about 850 m²/g to 1350 m²/g. The inert support is present in an amount of from about at least 30 wt % based on the total weight of the composition, and preferably from about 65 wt % to 75 wt %. Suitable examples of inert porous materials include, but are not limited to, activated carbon, alumina, silica, magnesium oxide, zirconium dioxide, and niobium pentoxide. A preferred inert support material is activated carbon.

An inert support is prepared by cutting and sieving extruded activated carbon (AC) to yield cylindrical AC particles ranging in size, for example, from about 2 mm to 4 mm. Commercial grade virgin AC can be readily obtained from several suppliers such as, for example, General Carbon Corporation, Paterson, N.J., Calgon Carbon Corporation of Pittsburgh, Pa., Cabot Norit Americas Inc. of Marshall, Tex., and Siemens Water Technologies of Alpharetta, Ga.

Prior to impregnating the inert support, the inert support may be washed with an acid solution such as, for example, nitric acid, acetic acid, formic acid, sulfuric acid, or the like, for one or more times to ensure removal of any contaminants such as, for example, metals.

The molybdenum oxides are preferably formed on the above washed and dried inert support (for example, activated carbon), by impregnating the inert support with the molybdenum oxide precursor (such as an aqueous solution of ammonium molybdate tetrahydrate (AMT)). The inert support can be impregnated with the molybdenum oxide precursor via a suitable method such as, for example, a rotary evaporation process, to achieve a molybdenum loading of from about 10 wt % to about 18 wt % based on the total weight of the impregnated inert support. Following impregnation, the impregnated AC particles are vacuum dried at about 80° C.

Once the molybdenum oxides are formed, a sulfur source such as, for example, hydrogen sulfide is placed in contact with molybdenum oxides to initiate simultaneous sulfidation and reduction reactions at a reaction temperature of from about 250° C. to about 650° C., for example about 400° C., until full sulfidation and reduction is achieved to yield a molybdenum-and sulfur-containing substance such as, for example, molybdenum disulfide. The combining of sulfidation and reduction steps represent an improvement over the preparation method described in U.S. Pat. No. 8,815,961 which employed reduction and sulfidation in two separate steps. The resulting product is then treated to remove any hydrogen sulfide physically adsorbed. This can be achieved by passing and purging an inert gas there through to strip away any remnant of hydrogen sulfide, and then allowing the sulfidized compound to cool under an inert atmosphere of nitrogen gas to yield sulfidized pellets containing molybdenum sulfide. The resulting product is stored under an inert atmosphere to prevent undesirable oxidation and moisture uptake that would otherwise occur in the presence of ambient air. It is noted that the sulfidation reactor in one embodiment is a quartz tube reactor.

In a particular embodiment of the present invention, the distribution of cesium uniformly through the molybdenum-and sulfur-containing substance can be achieved by impregnating it with a solution of a cesium-containing compound such as, for example, cesium formate, via a suitable method such as, for example, a rotary evaporation process, and drying the impregnated molybdenum-and sulfur-containing substance under an inert atmosphere. The amount of the cesium-containing compound solution applied is preferably selected to achieve a cesium to molybdenum mass ratio of at least 0.1, preferably from about 0.5 to 3 and more preferably about 1.

The impregnated pellets are vacuum-dried at about 80° C. and stored in an inert atmosphere (e.g., nitrogen gas). it is noted that care must be taken to avoid exposure of cesium to ambient air as cesium can readily absorb oxygen from ambient air and form undesirable cesium oxide species. The presence of such cesium oxide species can result in segregation of cesium in bulk phases on the active material and reduce catalyst activity for the WGSR. The resulting active material must be stored in an inert atmosphere (e.g., nitrogen purged bottles).

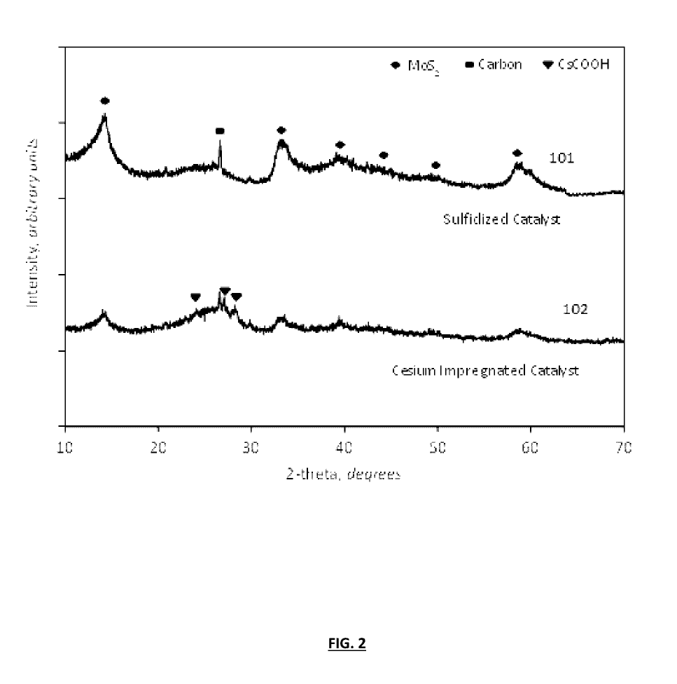

An X-ray powder diffraction (XRD) pattern of the sulfidized catalyst—MoS₂ on AC support and the cesium impregnated catalyst is shown in FIG. 2. To obtain the XRD pattern, in an embodiment, the sulfidized and cesium impregnated catalysts were analyzed using a RTGAKU MINIFLEX II diffractometer with a Cu Ka X-ray source (λ=1.54056 Å) operated at 3kV and 15 mA. As shown in plot 101 of FIG. 2, molybdenum was only present as MoS₂ after simultaneous sulfidation and reduction. Further, the low intensity and broader peaks of 101 indicate smaller particle sizes of MoS₂. The average MoS₂ crystal sizes after simultaneous sulfidation and reduction of AMT impregnated activated carbon pellets was determined to be 4.5 nm by HALDER WAGNER method using PDXL, software. After cesium formate impregnation, the MoS₂ crystal size was further reduced to 2.3 nm, indicating improved dispersion. The analysis yielded 12.3 wt % Mo, 8.7 wt % S. and 13.6 wt % Cs, corresponding to Cs_{0.8}/MoS_{2.1} supported on the high surface area activated carbon.

The present invention will now be described for catalyzing the water gas shift reaction using the catalyst composition of the present disclosure. The following description by no means limits the scope and spirit of the present invention.

In an embodiment, the WGSR may be shifted towards the production of more hydrogen gas using the catalyst composition of the current disclosure by contacting a reactant gas mixture comprising carbon monoxide, water vapor (steam), and hydrogen with the catalyst composition. In typical applications, the gas mixture may also contain carbon dioxide and inert gases such as nitrogen. The synthesis gas requires sufficient steam well in excess of stoichiometric quantity to allow the water-gas shift reaction to proceed. Synthesis gases derived from gasification processes may be deficient in steam and, if so, steam must be added. The steam may be added by direct injection or by another means such as a saturator or steam stripper. The amount of steam should desirably be controlled such that the total steam:CO gas volume ratio in the steam-enriched synthesis gas mixture fed to the catalyst is in the range 3:1 to 4:1. The catalysts of the present invention have found particular utility for synthesis gases with a steam:CO ratio in the range 3.1:1 to 3.7:1. The hydrogen to carbon monoxide gas volume ratio in the input stream can be between 1:1 to 3:1.

In an embodiment, prior to the reaction, the catalyst composition may be activated at ambient pressure under a stream of 10% H₂/N₂. The catalyst is heated to about 350 ° C. and the outlet gas is monitored by gas chromatography for the presence of water. When the water disappears from the outlet stream, the activation of the catalyst is complete.

The water-gas-shift catalyst is typically contained in a reaction chamber that preferably operated adiabatically. In some embodiments, the present catalyst composition can be used to catalyze the WGSR at a reaction temperature of less than 450° C., in some embodiments the temperature is in the range of 350 to 400° C., and in some embodiments in the range of 400 to 450° C., to maximize equilibrium CO conversion, and under a pressure 2.5 atm to 4 atm. In an embodiment, the reaction pressure may be between 1 atm—75 atm. In some embodiments, the reaction pressure may be 30 atm, 40 atm, 50 atm, or the like. In an embodiment of the present invention, the reactant gas mixture is passed through the catalyst composition at a gas hourly space velocity (GHSV) of from about 2400 L/kg catalyst/hr to about 5000 L/kg catalyst/hr.

Conversion of carbon monoxide (defined as CO mole change between reactant and product divided by moles CO in reactant), typically measured in conjunction within the above-described ranges, is preferably at least 50%; and in some preferred embodiments conversion is in the range of 50 to 80% . . The exit CO composition from the reactor may be calculated on a dry gas basis of the product gas stream, referred to as the % CO dry slip using mol %. In an embodiment, the % CO dry slip may be between 5% and 25%, preferably between 5% and 15%. The term “dry gas basis” means the composition of the gas mixture disregarding the steam content.

### EXAMPLES

The invention is further illustrated by reference to the following Examples that were carried out using a 25g charge of the catalyst composition loaded into a fixed bed reactor under N₂ environment and axially centered in the reactor using 2-3 mm Pyrex beads:

### Example 1

In a first test, a feed gas consisting of hydrogen, carbon monoxide, and steam (H₂:CO ratio of 2 and H₂O:CO ratio of 3.2) was passed at 2.8±0.1 atm, and at a GHSV of 3050±5 L/kg catalyst/hr through a bed of the catalyst composition. Three separate reaction temperatures were employed sequentially for this test, 358° C., 402° C. and 435° C. The steady state CO conversions measured in this test are reported in Table 1 below:

TABLE 1
Testing results for the Cs/MoS₂/AC Catalyst
as a function of temperature:

| Temperature (° C.) | CO Conv. (mol %) | CO Dry Slip (mol %) |
|---|---|---|
| 358 | 51.0 | 14.0 |
| 402 | 67.4 | 8.9 |
| 435 | 77.2 | 6.0 |

### Example 2

In a further test, a feed gas consisting of hydrogen, carbon monoxide, and steam (H₂:CO ratio of 2 and H₂O:CO ratio of 3.2) was passed at 2.8±0.1 atm, and at a reaction temperature of 356±3° C. The flow rate (GHSV) of the wet feed gas stream was varied sequentially for this test. The steady state CO conversions measured in this test are reported in Table 2 below:

TABLE 2
Testing results for the Cs/MoS₂/AC Catalyst
as a function of flow rate:

| GHSV (hr⁻¹) | CO Conv. (mol %) | CO Dry Slip (mol %) |
|---|---|---|
| 2449 | 54.8 | 12.8 |
| 3042 | 48.5 | 14.8 |
| 4738 | 30.4 | 21.1 |

### Example 3

In a further test, a feed gas consisting of hydrogen, carbon monoxide, and steam (H₂O:CO ration of 3.1) was passed at 2.5±0.3 atm, and at a reaction temperature of 404±2° C. The flow rate (GHSV) of the wet feed gas stream was varied sequentially for this test, and the H₂:CO molar ratio was varied from 1 to 2. The steady state CO conversions measured in this test are reported in Table 3 below (no formation of methanol or hydrocarbons was detected):

TABLE 3
Testing results for the Cs/MoS₂/AC Catalyst
with H₂/CO syngas ratios of 1 and 2:

| H₂/CO | GHSV (hr⁻¹) | CO Conv. (mol %) | CO Dry Slip (mol %) |
|---|---|---|---|
| 1 | 3010 | 63.6 | 13.8 |
| 2 | 3055 | 67.4 | 8.9 |

### Example 4

In another test, a feed gas consisting of hydrogen, carbon monoxide, and steam (H₂O:CO ration of 3.1-3.7) was passed at 2.55±0.25 atm, at a reaction temperature of 438±3° C., and at a flow rate of 3040±3 L/kg catalyst/hr through a bed of the catalyst composition. The H₂:CO molar ratio of the feed gas stream was varied sequentially for this test from 1-3. The steady state CO conversions measured in this test are reported in Table 4 below (no formation of methanol or hydrocarbons was detected):

TABLE 4
Testing results for the Cs/MoS₂/AC
Catalyst with H₂/CO syngas ratios:

| H₂/CO | CO Conv. (mol %) | CO Dry Slip (mol %) |
|---|---|---|
| 1 | 78.4 | 7.8 |
| 2 | 77.2 | 6.0 |
| 3 | 73.0 | 5.7 |

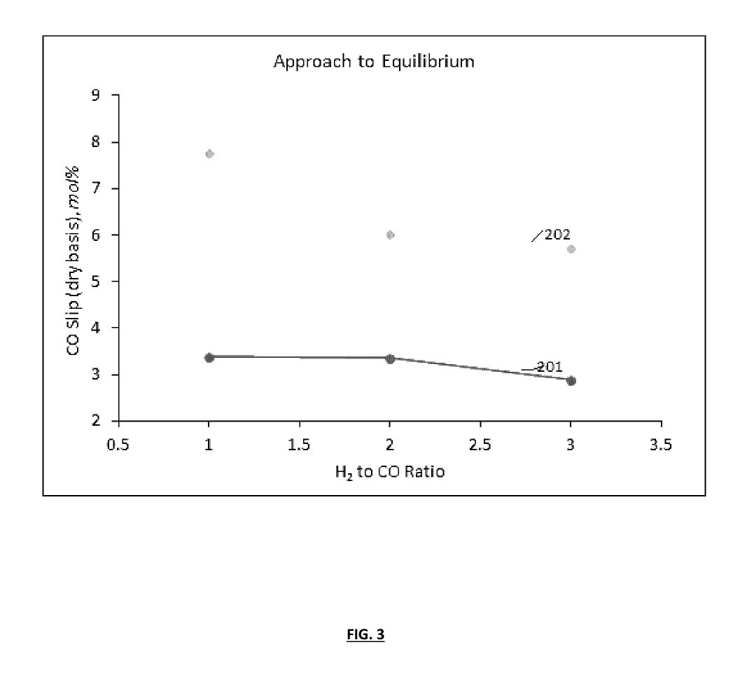

FIG. 3 illustrates the results of the above example 4 in the form of close to equilibrium curves. Curve 201 illustrates the isothermal equilibrium line and curve 202 illustrates the adiabatic equilibrium line. It should be noted that the % CO dry slip values in the present of the catalyst composition of this disclosure for WGSR approach the adiabatic equilibrium line 202 and are indicative of good catalyst performance.

The forgoing discussion discloses and describes merely exemplary embodiments of the present invention. One skilled in the art will readily recognize from such discussion, and from the accompanying claims, that various changes, modifications, and variations can be made therein without departing from the spirit and scope of the invention as defined in the following claims.

1. A method of increasing hydrogen content of a synthesis gas via a water-gas shift reaction comprising:
providing a stable catalyst composition comprising cesium and molybdenum sulfide on an inert support, wherein:
during catalyst formation sulfidation of molybdenum oxide occurs prior to impregnation of the cesium, and
the molybdenum sulfide of the stable catalyst composition does not loose sulfur during a water-gas shift reaction;
flowing a reactant gas mixture into contact with the catalyst composition, wherein the reactant gas mixture comprises synthesis gas (carbon monoxide and hydrogen) and steam; and
forming a hydrogen enriched shifted gas mixture.

2. (canceled)

3. The method of claim 1, wherein the inert support is activated carbon.

4. The method of claim 1, wherein the water gas shift reaction is carried out at a temperature of about 350° C. to 450° C.

5. The method of claim 1, further comprising activating the catalyst composition before flowing the reactant gas mixture into contact with the catalyst composition, wherein activating the catalyst composition comprises heating the catalyst composition to about 350° C. under a stream of hydrogen and nitrogen mixture.

6. The method of claim 1, wherein the water gas shift reaction is carried out at a pressure of at least 2.5 atm.

7. The method of claim 1, wherein the reactant gas mixture is flowed at a gas hourly space velocity of from about 2400 L/kg catalyst/hr to 5000 L/kg catalyst/hr.

8. The method of claim 1, wherein the water gas shift reaction is a sour feed reaction.

9. The method of claim 1, wherein the water gas shift reaction is a sweet feed reaction.

10. The method of claim 1, wherein carbon monoxide conversion is at least 50%.

11. The method of claim 10, wherein carbon monoxide conversion is from about 50% to 80%.

12. The method of claim 1, wherein carbon monoxide dry slip % in the hydrogen enriched shifted gas mixture is from about 5% to 15%.

13. The method of claim 1, wherein the synthesis gas comprises a hydrogen to carbon monoxide volume ratio in the range of from 1 to 3.

14. The method of claim 1, wherein the reaction gas mixture comprises a steam to carbon monoxide volume ratio in the range of from 3 to 4.

15. A method of preparing a catalyst composition, comprising:
forming oxides of molybdenum on an inert activated carbon support from a molybdenum oxide precursor, via impregnation;
simultaneously, sulfidizing and reducing, the formed molybdenum oxides, by passing a mixture of hydrogen sulfide and hydrogen in contact with the formed molybdenum oxides at a reaction temperature for a sufficient time to yield molybdenum disulfide, wherein the reaction temperature is between 250° C. to about 650°0 C;
removing any hydrogen sulfide physically adsorbed on the molybdenum disulfide; and
distributing cesium uniformly through said molybdenum-and sulfur-containing substance.

16. The method of claim 15, wherein the molybdenum oxide precursor is ammonium molybdate tetrahydrate.

17. The method of claim 15, wherein the molybdenum oxide precursor solution is applied in an amount sufficient to achieve a molybdenum loading of from about 10 wt % to 18 wt % based on the total weight of the impregnated inert activated carbon support.

18. The method of claim 15, wherein the molybdenum oxide precursor is reduced and sulfidized at from about 250° C. to 650° C.

19. The method of claim 15, wherein the cesium-containing compound solution is applied in an amount sufficient to achieve a cesium to molybdenum mass ratio in the range of from 0.1 to 3 or preferably about 1.

20. The method of claim 19, wherein the cesium-containing compound is cesium formate.
